(19) United States
(12) Patent Application Publication
(10) Pub. No.: US 2002/0169908 A1
(43) Pub. Date: Nov. 14, 2002

(54) System and method for implementing a flexible arbitration mechanism

(75) Inventor: Mitsuaki Shiraga, Saratoga, CA (US)

Correspondence Address: Gregory J. Koerner, SIMON & KOERNER LLP, Suite B, 10052 Pasadena Avenue, Cupertino, CA, 95014, US

(73) Assignee: Sony Corporation

(21) Appl. No.: 09/852,098

(22) Filed: May 8, 2001

(51) Int. Cl. G06F 12/00; G06F 13/14; G06F 13/38

(52) U.S. Cl. 710/240

(57) ABSTRACT

An apparatus and method for implementing a flexible arbitration mechanism in an electronic system may preferably include a plurality of command sources coupled to the electronic system for generating pending commands. An arbiter coupled to the electronic system may preferably reference a configurable arbitration table to choose a next table entry corresponding to a selected command from the pending commands for execution by the electronic system. The arbitration table may preferably include ordered entries that correspond to the pending commands. The arbiter may preferably reference the configurable arbitration table during a table analysis sequence to thereby identify the foregoing selected command. Configuration logic coupled to the electronic system may preferably perform a dynamic arbitration configuration procedure to advantageously reconfigure the arbitration table in response to a configuration request that may preferably be generated after a system CPU device reprograms an arbitration configuration register in the electronic system in response to software program instructions.

### BACKGROUND SECTION

1. Field of the Invention

This invention relates generally to techniques for managing electronic systems, and relates more particularly to a system and method for implementing a flexible arbitration mechanism.

2. Description of the Background Art

Implementing efficient methods for managing electronic systems is a significant consideration for designers and manufacturers of contemporary electronic devices. However, efficiently managing electronic systems may create substantial challenges for system designers. For example, enhanced demands for increased device functionality and performance may require more system processing power and require additional hardware resources. An increase in processing or hardware requirements may also result in a corresponding detrimental economic impact due to increased production costs and operational inefficiencies.

Furthermore, enhanced device capability to perform various advanced operations may provide additional benefits to a system user, but may also place increased demands on the control and management of various device components. For example, an enhanced electronic device that manages digital image data may benefit from an effective implementation because of the large amount and complexity of the digital data involved.

In certain environments, multiple system entities may require access to a particular system resource. For example, various peripheral devices in an electronic system may require access to a memory resource that services the electronic system. Flexible and efficient performance of corresponding arbitration procedures to manage access to the memory resource may become significant in successfully implementing and operating the electronic system.

Due to growing demands on system resources and substantially increasing data magnitudes, it is apparent that developing new techniques for system management is a matter of concern for related electronic technologies. Therefore, for all the foregoing reasons, developing efficient systems for managing electronic systems remains a significant consideration for designers, manufacturers, and users of contemporary electronic devices.

### SUMMARY

In accordance with the present invention, a system and method are disclosed for efficiently implementing a flexible arbitration mechanism. In one embodiment, initially, various appropriate entities (such as a CPU or various peripheral devices) may preferably generate pending commands to corresponding command interfaces of a memory interface. The foregoing command interfaces may responsively each request an arbiter to perform an arbitration procedure with respect to the pending commands.

The arbiter may preferably examine an arbitration table for the pending commands by utilizing any effective and appropriate technique. For example, in certain embodiments, the arbiter may preferably utilize a table analysis sequence to identify a next table entry that corresponds to a particular selected command from among the foregoing pending commands. The arbiter may then preferably notify a corresponding command interface regarding the selected command that is associated with the previously-determined next table entry.

The command interface may responsively send the selected command to a memory controller of a memory interface which may preferably format the selected command, and then send the selected command to a memory device. In response, the memory device may preferably execute the selected command. Then, the arbiter may preferably determine whether pending commands remain to be executed. If pending commands remain, then the arbitration process may preferably repeat the foregoing steps to arbitrate the additional pending commands. However, if no pending commands remain, then the arbitration procedure may preferably terminate.

The electronic system may also perform a flexible arbitration configuration procedure in which the CPU may preferably reprogram an arbitration configuration register with updated values for the arbitration table that may then be utilized by the arbiter to perform the foregoing arbitration procedure. Configuration logic may responsively detect the foregoing change in arbitration configuration register by utilizing any effective means. For example, the configuration logic may utilize a comparator device to detect the change in the arbitration configuration logic by comparing a local register with the arbitration configuration register.

The configuration logic may preferably generate an arbitration configuration request in response to detecting a change in the arbitration configuration register. The configuration logic may then preferably monitor a current state of the memory device by utilizing any effective means. For example, the configuration logic may monitor activity of a memory bus through the memory controller.

The configuration logic may thus preferably determine whether the memory device is current in an idle state. In the event that the memory device is currently idle, then the configuration logic may preferably download the updated contents of the arbitration configuration register into the local register. The arbiter may then advantageously configure the arbitration table with the updated contents of the local register to thereby complete the arbitration configuration procedure. The present invention thus provides an improved system and method for implementing a flexible arbitration mechanism.

### BRIEF DESCRIPTION OF THE DRAWINGS

FIG. 1 is a block diagram for one embodiment of an electronic system, in accordance with the present invention;

FIG. 2 is a block diagram for one embodiment of the bridge device of FIG. 1, in accordance with the present invention;

FIG. 3 is a block diagram for one embodiment of the memory of FIG. 1, in accordance with the present invention;

FIG. 4 is a block diagram for one embodiment of the memory interface of FIG. 2, in accordance with the present invention;

FIGS. 5A through 5E are block diagrams for exemplary embodiments of the arbitration table of FIG. 4, in accordance with one embodiment of the present invention;

FIG. 6 is a diagram of a table analysis sequence for determining next table entries, in accordance with one embodiment of the present invention;

FIG. 7 is a flowchart of method steps for performing an arbitration procedure, in accordance with one embodiment of the present invention;

FIG. 8 is a timing diagram illustrating an arbitration configuration procedure, in accordance with one embodiment of the present invention; and

FIG. 9 is a flowchart of method steps for performing an arbitration configuration procedure, in accordance with one embodiment of the present invention.

### DETAILED DESCRIPTION

The present invention relates to an improvement in system management techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention comprises an apparatus and method for implementing a flexible arbitration mechanism in a electronic system, and may preferably include a plurality of command sources coupled to the electronic system for generating pending commands. An arbiter coupled to the electronic system may preferably reference a configurable arbitration table to identify a next table entry corresponding to a selected command from the pending commands for execution by the electronic system. The arbitration table may preferably include ordered entries that correspond to the pending commands. The arbiter may preferably reference the configurable arbitration table during a table analysis sequence to thereby choose the foregoing selected command. Configuration logic coupled to the electronic system may preferably perform a dynamic arbitration configuration procedure to advantageously reconfigure the arbitration table in response to a configuration request that may preferably be generated after a system CPU device reprograms an arbitration configuration register in the electronic system in response to software program instructions.

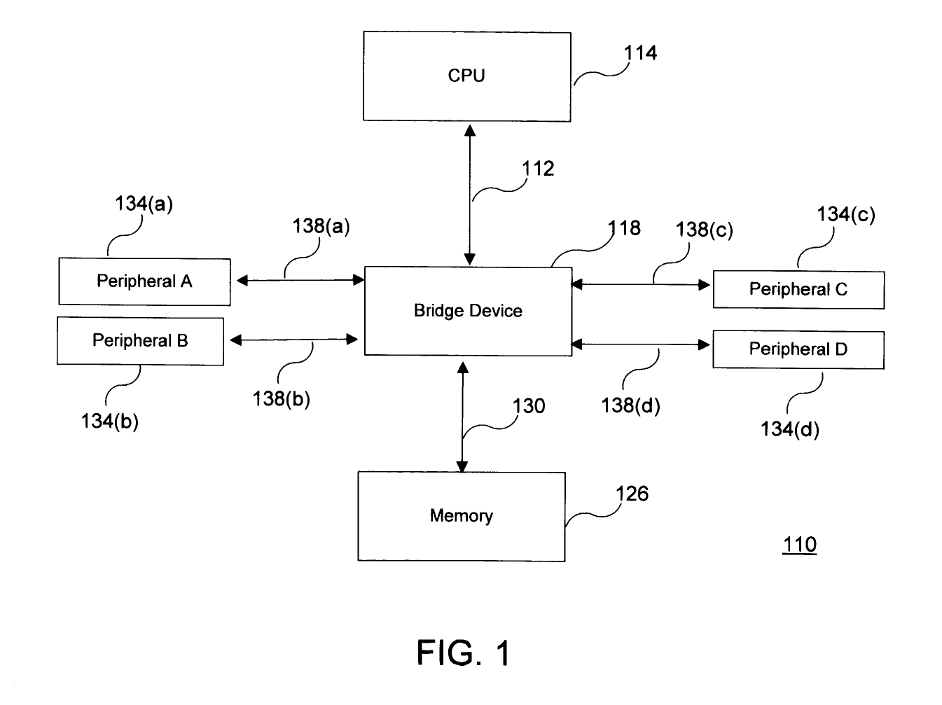

Referring now to FIG. 1, a block diagram for one embodiment of an electronic system 110 is shown, in accordance with the present invention. In the FIG. 1 embodiment, electronic system 110 may preferably include, but is not limited to, a central processing unit (CPU) 114, a bridge device 118, a memory 126, a peripheral A 134(a), a peripheral B 134(b), a peripheral C 134(c), and a peripheral D 134(d). In alternate embodiments, electronic system 110 may readily include various other elements or functionalities in addition to, or instead of, those elements or functionalities discussed in conjunction with the FIG. 1 embodiment. Furthermore, electronic system 110 may be implemented and configured in any desired manner. For example, electronic system 110 may be implemented as one or more integrated circuit devices, as a audio/visual electronic device, as a consumer electronics device, as a portable electronic device, or as a computer device.

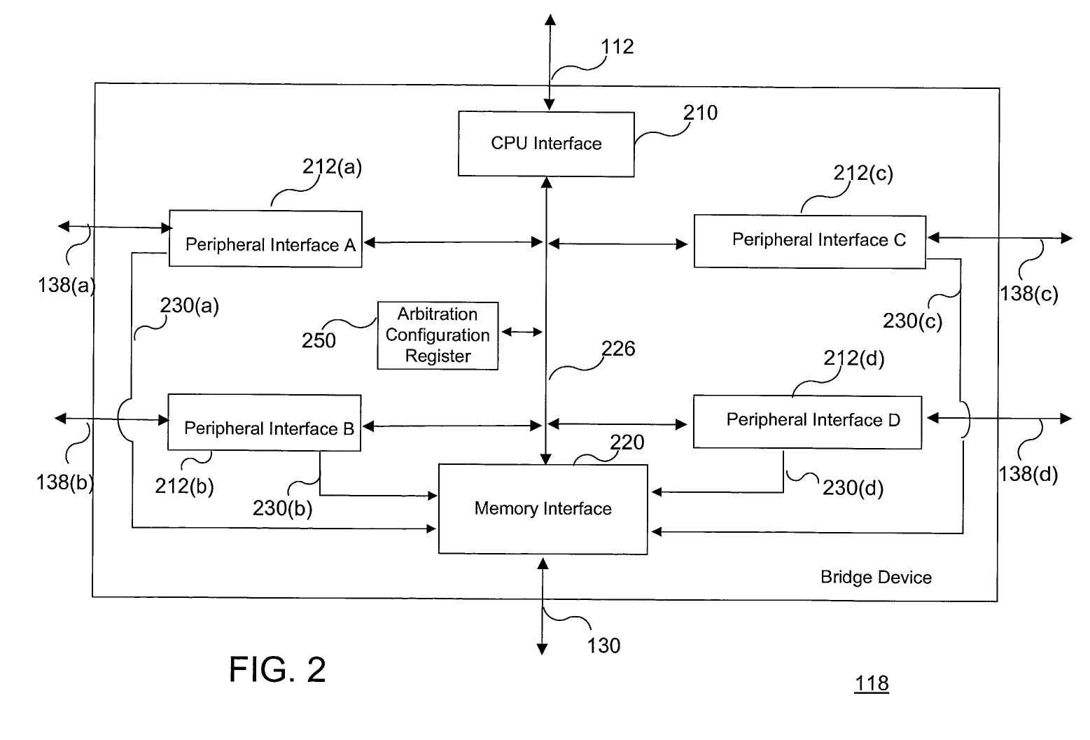

In the FIG. 1 embodiment, CPU 114 may preferably be implemented as any appropriate and effective processor device or microprocessor to thereby control and coordinate the operation of electronic system 110 in response to various software program instructions. Bridge device 118 may communicate with CPU 114 via path 112, and may preferably include one or more interfaces for bidirectionally communicating with other devices or entities in electronic system 110. One embodiment of bridge device 118 is further discussed below in conjunction with FIG. 2.

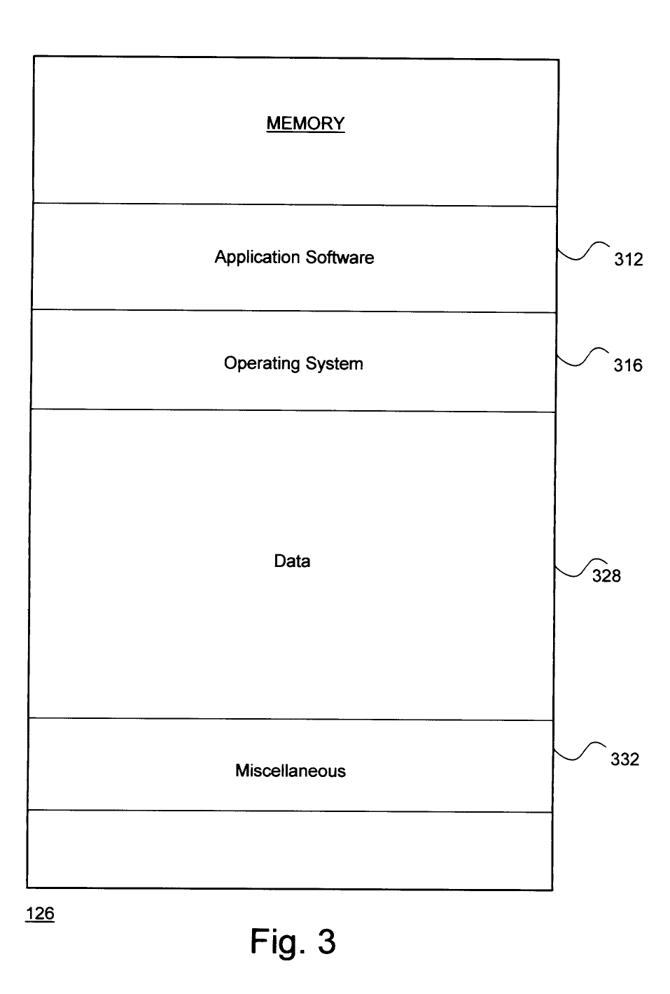

In the FIG. 1 embodiment, memory 126 may bidirectionally communicate with bridge device 118 via path 130. Memory 126 may be implemented by utilizing any desired technologies or configurations. For example, in certain embodiments, memory 126 may preferably be implemented as a memory device that is optimized for performing block transfers of various data. One implementation and configuration for memory 126 is further discussed below in conjunction with FIG. 3.

In accordance with the present invention, bridge device 118 may also bidirectionally communicate with various peripheral devices 134 in electronic system 110. In the FIG. 1 embodiment, bridge device 118 may preferably communicate with a peripheral A 134(a) via path 138(a), and may also preferably communicate with a peripheral B 134(b) via path 138(b). In addition, bridge device 118 may preferably communicate with a peripheral C 134(c) via path 138(c), and may also preferably communicate with a peripheral D 134(d) via path 138(d). In alternate embodiments, bridge device 118 may readily communicate with any desired number of peripheral devices in addition to, or instead of, those peripheral devices 134 that are presented and discussed in conjunction with the FIG. 1 embodiment.

Referring now to FIG. 2, a block diagram for one embodiment of the FIG. 1 bridge device 118 is shown, in accordance with the present invention. In the FIG. 2 embodiment, bridge device 118 may preferably include, but is not limited to, a CPU interface 210, a peripheral interface A 212(a), a peripheral interface B 212(b), a peripheral interface C 212(c), a peripheral interface D 212(d), and a memory interface 220. In alternate embodiments, bridge device 118 may readily include various other elements or functionalities in addition to, or instead of, those elements or functionalities discussed in conjunction with the FIG. 2 embodiment. In addition, bridge device 118 may be implemented in any appropriate manner. For example, in certain embodiments, bridge device 118 may be implemented as a separate integrated circuit device in electronic system 110.

In the FIG. 2 embodiment, CPU 114 may communicate with bridge device 118 through a CPU interface 210, and memory 126 may communicate with bridge device 118 through a memory interface 220. Similarly, peripheral A 134(a) may communicate with bridge device 118 through a peripheral interface A 212(a), and peripheral B 134(b) may communicate with bridge device 118 through a peripheral interface B 212(b). In addition, peripheral C 134(c) may communicate with bridge device 118 through a peripheral interface C 212(c), and peripheral D 134(d) may communicate with bridge device 118 through a peripheral interface D 212(d).

Bridge device 118 may preferably also include a bridge bus 226 to enable various components and devices in electronic system 110 to effectively communicate through bridge device 118. In addition, each peripheral interface 212 preferably include a separate path 230 to memory interface 220. In the FIG. 2 embodiment, bridge device 118 may also include an arbitration configuration register 250 that CPU 114 may program to initiate an arbitration configuration procedure, in accordance with the present invention. The functionality of bridge device 118 is further discussed below in conjunction with FIGS. 3 through 10.

Referring now to FIG. 3, a block diagram for one embodiment of the FIG. 1 memory 126 is shown, in accordance with the present invention. In the FIG. 3 embodiment, memory 126 may preferably include, but is not limited to, application software 312, an operating system 316, data 328, and miscellaneous routines 332. In alternate embodiments, memory 126 may readily include various other components in addition to, or instead of, those components discussed in conjunction with the FIG. 3 embodiment.

In the FIG. 3 embodiment, application software 312 may include program instructions that are preferably executed by CPU 114 (FIG. 1) to perform various functions and operations for electronic system 110. The particular nature and functionality of application software 312 may preferably vary depending upon factors such as the type and particular use of the corresponding electronic system 110.

In the FIG. 3 embodiment, operating system 316 preferably controls and coordinates low-level functionality of electronic system 110. Data 328 may preferably be implemented and configured to provide a location for storing any desired type of electronic data or other appropriate information. Miscellaneous routines 332 may include any desired additional software instructions to facilitate corresponding functions performed by electronic system 110.

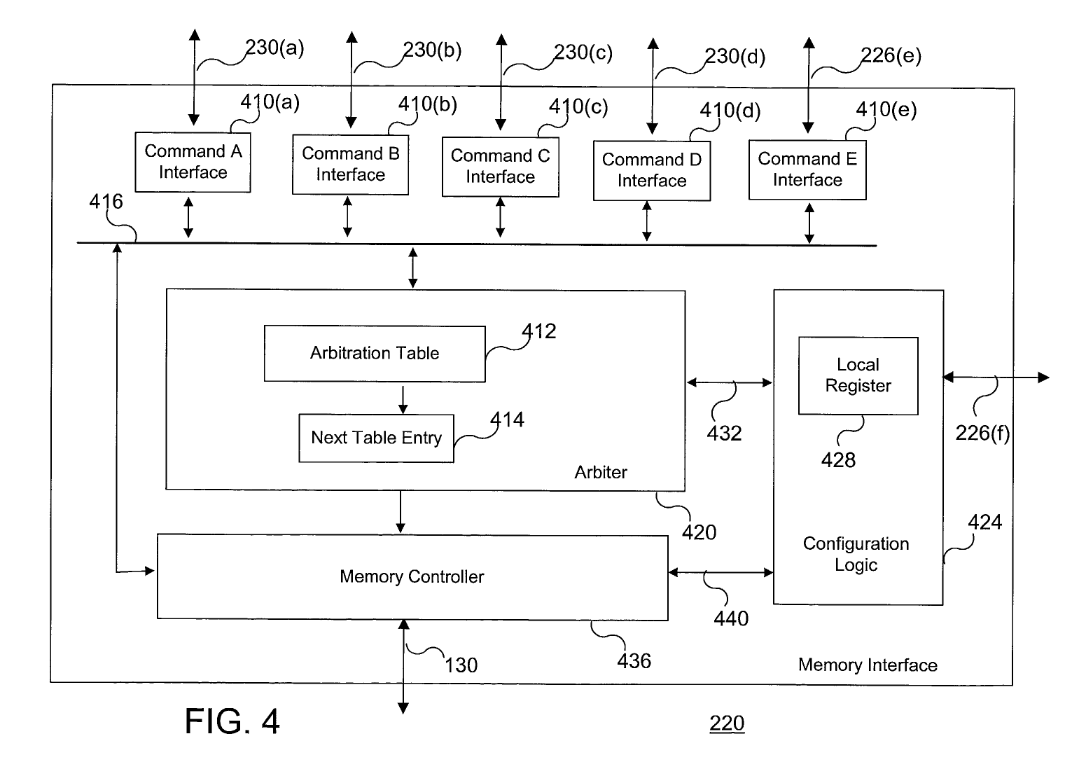

Referring now to FIG. 4, a block diagram for one embodiment of the FIG. 2 memory interface 220 is shown. In the FIG. 4 embodiment, memory interface 220 may preferably include, but is not limited to, a series of command interfaces 412, an arbiter 420, configuration logic 424, and a memory controller 436. In alternate embodiments, memory interface 220 may readily include various other elements or functionalities in addition to, or instead of, those elements or functionalities discussed in conjunction with the FIG. 4 embodiment.

For example, for purposes of clarity, FIG. 4 shows command interfaces 410, arbiter 420, and memory controller 436 as being connected by path 416. However, memory interface 220 may typically be implemented by utilizing individual paths between each command interface 410 and arbiter 420. Similarly, memory interface 220 may typically be implemented by utilizing individual paths between each command interface 410 and memory controller 436.

In the FIG. 4 embodiment, each of the command interfaces 410(a) through 410(e) may preferably receive a pending command from a respective device in electronic system 110 via a corresponding input path. In the FIG. 4 embodiment, the pending commands may preferably include at least one of a read data transfer command and a write data transfer command. However, commands of any nature are within the scope of the present invention. In the FIG. 4 embodiment, command E interface 410(e) may preferably correspond to CPU 114, while the remaining command interfaces 410(a) through 410(d) may preferably correspond to a peripheral device 134 that is designated by an identical alphabetical identifier. For example, command A interface 410(a) may preferably receive pending commands from peripheral A 134(a) through peripheral interface A 212(a).

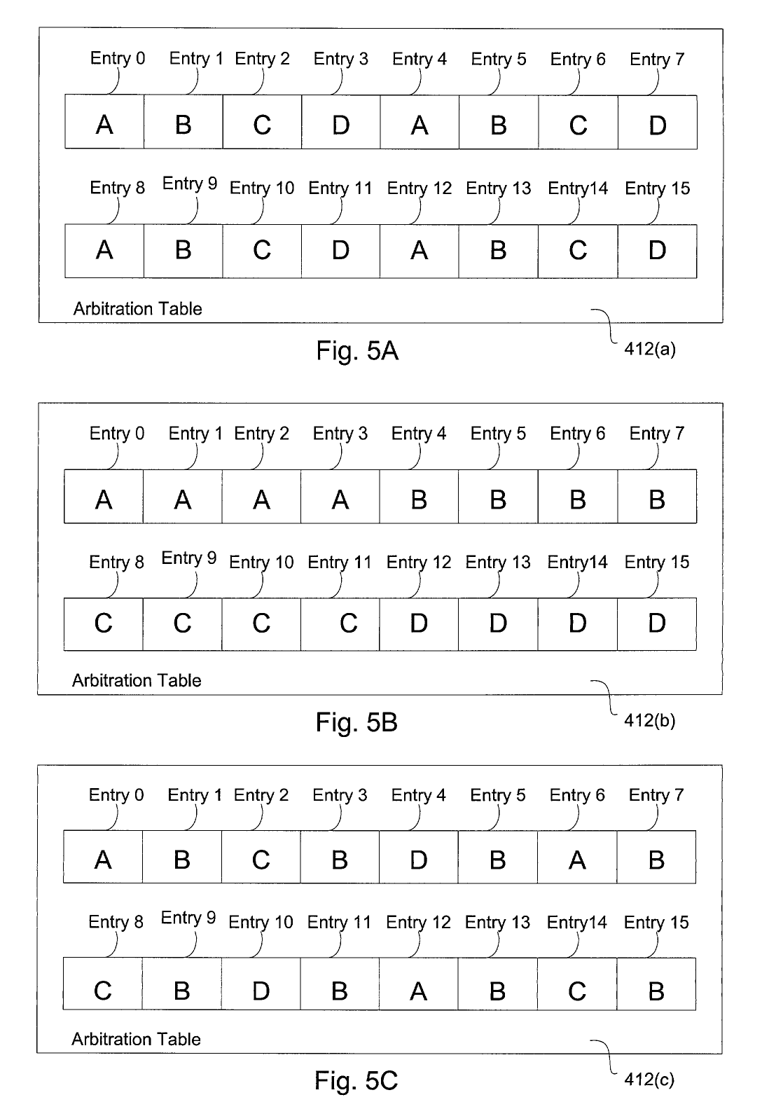

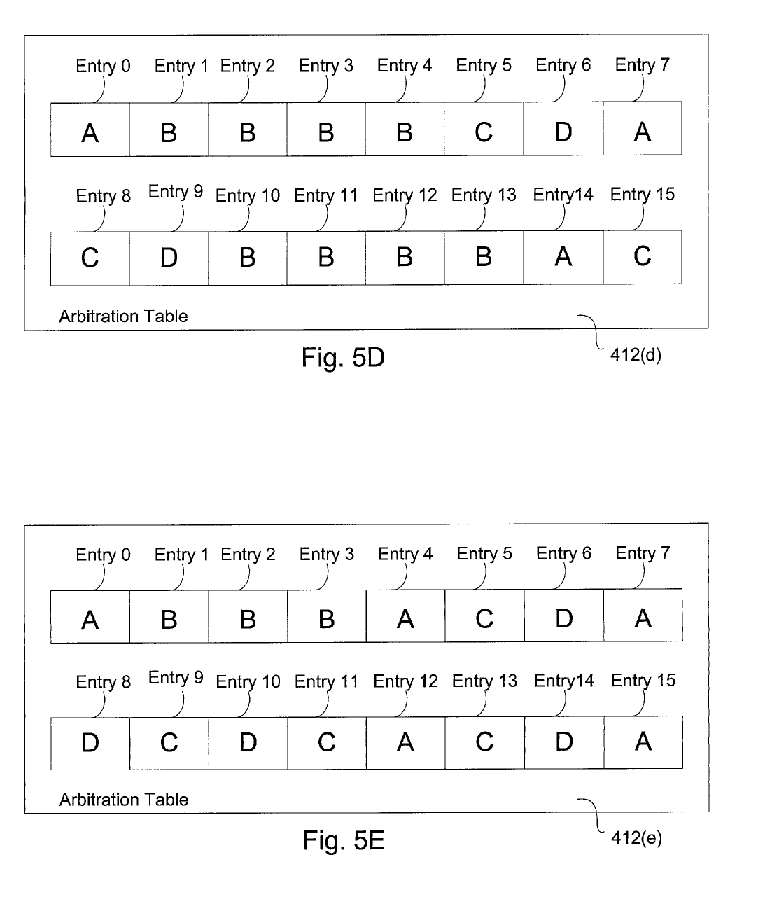

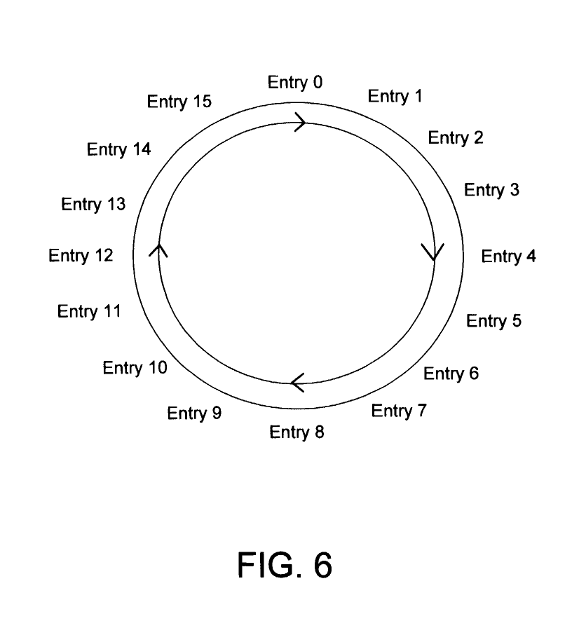

In the FIG. 4 embodiment, when a command interface 410 receives a pending command, then that command interface 410 may preferably notify arbiter 420 regarding the pending command via path 416. In response, arbiter 420 may preferably examine arbitration table 412 to determine a next table entry 414, as discussed below in conjunction with FIGS. 5A-5E and FIG. 6.

In the FIG. 4 embodiment, after arbiter identifies a next table entry 414, arbiter 420 may preferably notify the appropriate command interface 410 via path 416 that the pending command corresponding to the next table entry has been identified as a selected command by arbiter 420 for the next access to memory 126. The foregoing command interface 410 may responsively provide the selected command to memory controller 436 via path 416. Memory controller 436 may then format the selected command which may then preferably be provided to memory 126 via path 130 for execution.

In the FIG. 4 embodiment, configuration logic 424 may dynamically perform an arbitration configuration procedure to alter the contents of arbitration table 412 to thereby provide altered arbitration functionality for optimizing performance characteristics of electronic system 110. In practice, configuration logic 424 may monitor an arbitration configuration register 250 (FIG. 2) that may advantageously be reprogrammed by CPU 114 in response to various software instructions from an appropriate entity (such as application software 312).

In the FIG. 4 embodiment, configuration logic 424 may preferably compare the contents of arbitration configuration register 250 with the contents of local register 428 to detect a change in arbitration configuration register 250. After detecting a change in arbitration configuration register 250, then configuration logic 424 may preferably monitor a current memory state of memory 126 using any suitable technique. In the FIG. 4 embodiment, configuration logic 424 may preferably monitor activity of a memory bus 130 through memory controller 436 via path 440.

When configuration logic 424 determines that memory 126 is currently in an idle state, then configuration logic 424 may preferably download the reprogrammed contents of arbitration configuration register 250 into local register 428 via path 226(f). Arbiter 420 may then access local register 428 to update the entries in arbitration table 412 to thereby complete the arbitration configuration procedure. The functionality of memory interface 220 is further discussed below in conjunction with FIGS. 5 through 9.

Referring now to FIG. 5A through FIG. 5E, block diagrams for exemplary embodiments of the FIG. 4 arbitration table 420 are shown, in accordance with the present invention. The embodiments of arbitration table 412 shown in FIGS. 5A through 5E are presented for purposes of illustration. In alternate embodiments, arbitration table 412 may readily include various other elements or functionalities in addition to, or instead of, those elements or functionalities discussed in conjunction with the FIG. 5 embodiment. For example, arbitration table 412 may be implemented to include any number of storage locations that contain any desired sequence of entries.

In the FIG. 5 embodiments, the exemplary arbitration tables 412 may preferably include a series of sixteen locations that preferably each correspond to a different respective entry 0 through entry 15. Each entry may preferably correspond to a particular command source in electronic system 110. In the FIG. 5 examples, four command sources are represented, with an entry “A” corresponding to a command source A, an entry “B” corresponding to a command source B, an entry “C” corresponding to a command source C, and an entry “D” corresponding to a command source D.

Arbitration table 412(a) illustrates a fairness arbitration table for normal use in electronic system 110 in which each command source is alternately and equally represented. Arbitration table 412(b) illustrates a fairness burst arbitration table for burst transfers to or from each command source in electronic system 110 in which each command source is equally represented and alternately receives four consecutive entries in arbitration table 412(b).

Arbitration table 412(c) illustrates a periodic source arbitration table that may be utilized to ensure that a particular command source in electronic system 110 may receive regular and guaranteed access to memory 126. In arbitration table 412(c), command source B occupies alternate entries throughout arbitration table 412(c). Arbitration table 412(c) may be beneficially utilized for applications such as those in isochronous data environments that may require guaranteed and deterministic access to memory 126.

Arbitration table 412(d) illustrates a heavily-weighted partial burst arbitration table that may be utilized to ensure that a particular command source in electronic system 110 may receive periodic access to memory 126 to perform burst transfer operations. In arbitration table 412(d), command source B periodically occupies four successive entries in arbitration table 512(d). Arbitration table 412(e) illustrates a lightly-weighted partial burst arbitration table that may be utilized to ensure that a particular command source in electronic system 110 may receive lightly-weighted burst access to memory 126 to perform a burst transfer operation. In arbitration table 412(e), command source B occupies three successive entries in arbitration table 412(e).

Referring now to FIG. 6, a diagram of a table analysis sequence 710 for determining next table entries 414 is shown, in accordance with one embodiment of the present invention. In alternate embodiments, table analysis sequences may readily include various other elements, functionalities, or sequences in addition to, or instead of, those elements, functionalities, or sequences discussed in conjunction with the FIG. 6 embodiment.

The following discussion of the FIG. 6 embodiment is presented for purposes of illustration, and may be better understood when taken in combination with the principles and configurations previously discussed in conjunction with the arbitration tables 412 of FIG. 5. Therefore, entry 0 through entry 15 of the FIG. 6 table analysis sequence 710 may preferably correspond to similar entries in the arbitration tables 412 of FIGS. 5A through 5E.

In the FIG. 6 embodiment, in order to identify a next table entry 414, arbiter 420 may preferably examine a particular arbitration table 412 by initially evaluating entry 0. For cases in which all entries of arbitration table 412 have pending commands, then arbiter 420 may preferably evaluate all entries of arbitration table 412 in an ascending order, and may sequentially choose individual next table entries 414 from table analysis sequence 710 by proceeding from lower-numbered entries to higher-numbered entries, as shown by the clockwise arrows in FIG. 6. In certain embodiments, arbiter 420 may analyze all entries of arbitration table 412 in a substantially concurrent manner to determine a series of next table entries 414.

However, for cases in which all entries of arbitration table 412 do not have pending commands, then arbiter 420 may preferably examine only those selected entries in table analysis sequence 710 that correspond to pending commands. Arbiter 420 may thus skip over locations of arbitration table 412 that do not correspond to currently pending commands. In certain embodiments, arbiter 420 may analyze arbitration table 412 in a substantially concurrent manner to identify only those entries that correspond to currently pending commands.

In practice, arbiter 420 may preferably select an initial next table entry 414 from the lowest-numbered entry in table analysis sequence 710 that corresponds to a currently pending command. After that initial command is executed, arbiter 420 may then continue to repeatedly select additional next table entries 414 by examining each entry of table analysis sequence 710 in an ascending entry-number order to locate successive entries that are associated with currently pending commands.

In the FIG. 6 embodiment, arbiter 420 may preferably utilize a rotating examination sequence in table analysis sequence 710 for performing successive arbitration procedures. Arbiter 420 may thus preferably utilize a series of variable entries in table analysis sequence 710 as changing starting points for performing successive arbitration procedures to thereby identify corresponding next table entries 414.

For example, if arbiter 420 initially identifies a next table entry 414 at entry 3 of table analysis sequence 710, then arbiter 420 may preferably perform the immediately-following arbitration procedure by evaluating table analysis sequence 710 beginning at entry 4 and ending at entry 3. The starting entry utilized by arbiter 420 may therefore preferably rotate around table analysis sequence 710 each time a new next table entry 414 is located.

In the FIG. 6 embodiment, after arbiter 420 identifies a next table entry 414 in the foregoing table analysis sequence 710, then arbiter 420 may preferably notify an appropriate command interface 410 regarding that particular next table entry 414 to thereby designate a pending command corresponding to the next table entry 414 as the selected command of the current arbitration procedure.

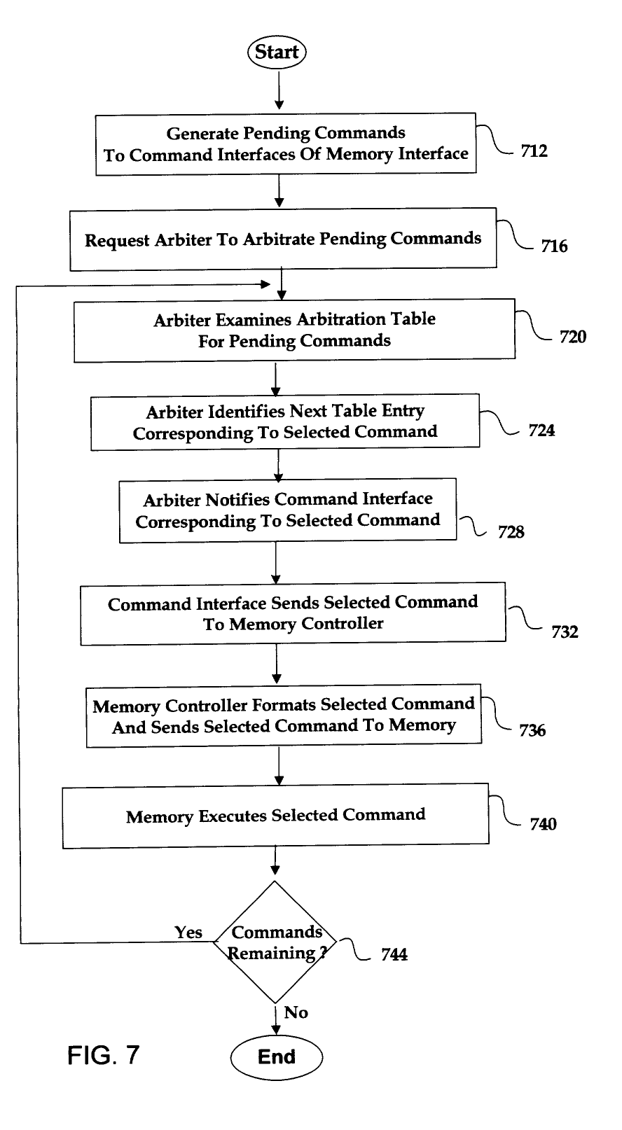

Referring now to FIG. 7, a flowchart of method steps for performing an arbitration procedure is shown, in accordance with one embodiment of the present invention. The FIG. 7 embodiment is presented for purposes of illustration, and in alternate embodiments, the present invention may readily utilize various steps and sequences other than those discussed in conjunction with the FIG. 7 embodiment.

In the FIG. 7 embodiment, in step 712, various appropriate entities (such as CPU 114 or peripheral devices 134) may preferably generate pending commands to corresponding command interfaces 410 of memory interface 220. In step 716, the foregoing command interfaces 410 may responsively each request arbiter 420 to perform an arbitration procedure with respect to the pending commands.

In step 720, arbiter 420 may preferably examine arbitration table 412 for the pending commands by utilizing any effective and appropriate technique. For example, in certain embodiments, arbiter 420 may preferably utilize a table analysis sequence 710 that is discussed above in conjunction with FIG. 6. In step 724, arbiter 420 may preferably identify a next table entry 414 that corresponds to a particular selected command from among the foregoing pending commands.

In step 728, arbiter 420 may preferably notify a corresponding command interface 410 regarding the selected command that is associated with the next table entry 414 determined in foregoing step 724. In step 732, the command interface 410 may preferably send the selected command to memory controller 436 of memory interface 220.

In step 736, memory controller 436 may preferably format the selected command, and then send the selected command to memory 126. In response, memory 126 may preferably execute the selected command. Then, in step 744, arbiter 420 may preferably determine whether pending commands remain to be executed. If pending commands remain, then the FIG. 7 process may preferably return to step 720 to repeat the foregoing arbitration procedure. However, if no pending commands remain, then the FIG. 7 procedure may preferably terminate.

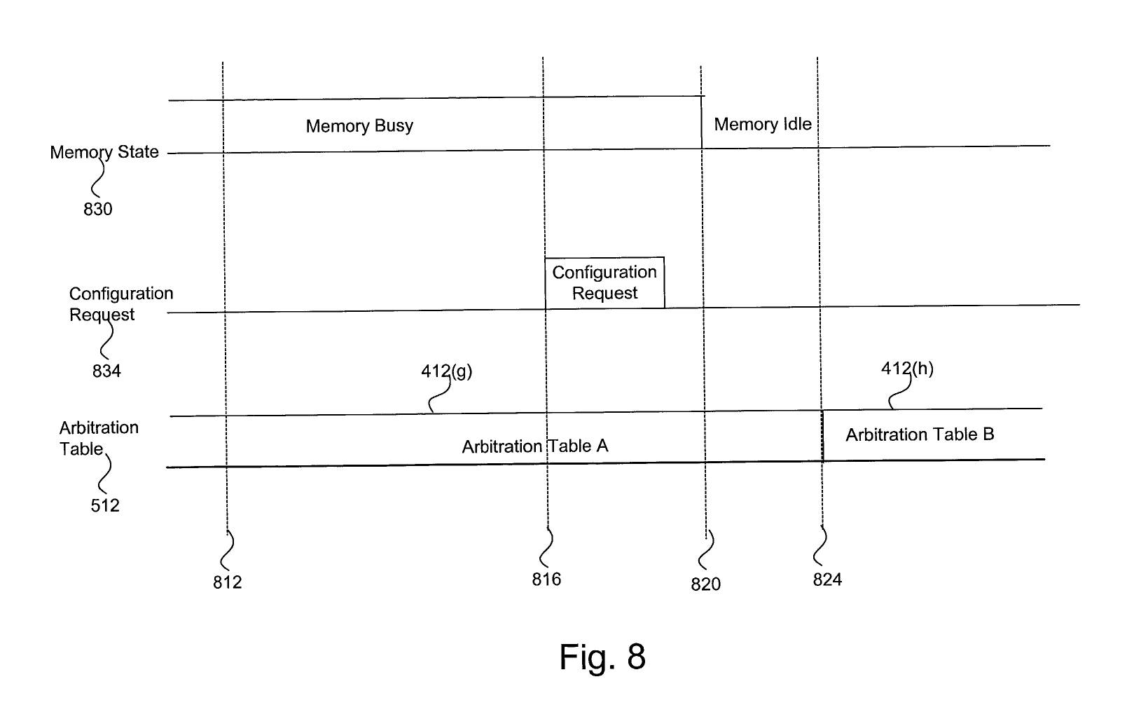

Referring now to FIG. 8, a timing diagram illustrating an arbitration configuration procedure is shown, in accordance with one embodiment of the present invention. In alternate embodiments, an arbitration configuration procedure may readily include various other timings, elements, or functionalities in addition to, or instead of, those timings, elements, or functionalities discussed in conjunction with the FIG. 8 embodiment.

In the FIG. 8 embodiment, at time 812, an arbitration table A 412(g) is preferably configured in electronic system 110 for utilization by arbiter 420. Memory 126 is also currently in a busy state at time 812. Then, at time 816, configuration logic 424 may preferably generate a configuration request after detecting that CPU 114 has reprogrammed an arbitration configuration register 250.

Configuration logic 424 may then wait until memory 126 enters an idle state at time 820 before beginning an arbitration configuration procedure to update arbitration table 412. Finally, at time 824, an arbitration table B 412(h) has preferably be configured for utilization by arbiter 420, in accordance with the present invention.

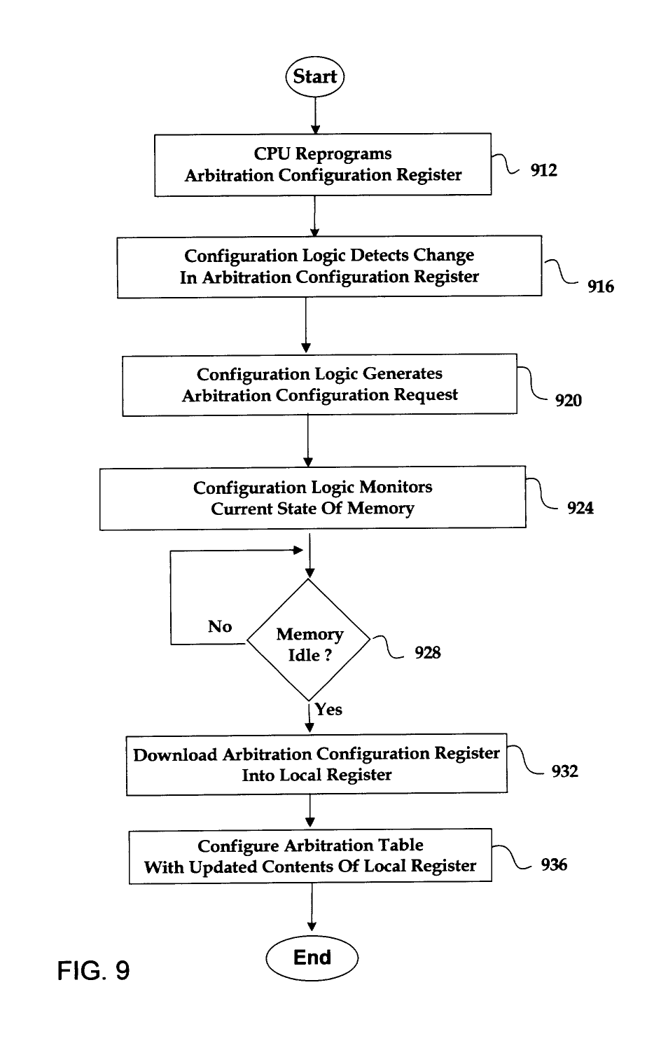

In alternate embodiments, configuration logic 424 need not wait until memory 126 enters an idle state at time 820 before beginning an arbitration configuration procedure to update arbitration table 412. For example, in certain embodiments, configuration logic 424 may update arbitration table 412 while memory 126 is active, and arbiter 420 may responsively utilize the updated arbitration table 412 to perform the next arbitration procedure. The FIG. 8 arbitration configuration procedure is further discussed below in conjunction with FIG. 9.

Referring now to FIG. 9, a flowchart of method steps for performing an arbitration configuration procedure is shown, in accordance with one embodiment of the present invention. The FIG. 9 embodiment is presented for purposes of illustration, and in alternate embodiments, the present invention may readily utilize various steps and sequences other than those discussed in conjunction with the FIG. 9 embodiment.

In the FIG. 9 embodiment, in step 912, CPU 114 may preferably reprogram an arbitration configuration register 250 with updated values for an arbitration table 412 that may then be utilized by an arbiter 420 to perform a command arbitration procedure, as discussed above in conjunction with FIG. 7. Then, in step 916, configuration logic 424 may preferably detect the foregoing change in arbitration configuration register 250 by utilizing any effective means. For example, configuration logic 424 may utilize a comparator device to detect the change in arbitration configuration logic 424 by comparing a local register 428 with arbitration configuration register 250.

In step 920, configuration logic 424 may preferably generate an arbitration configuration request after detecting the change in arbitration configuration register 250. In step 924, configuration logic 424 may preferably monitor a current state of memory 126 by utilizing any effective means. For example, configuration logic 424 may monitor activity of a memory bus 130 through a memory controller 436.

In step 928, configuration logic determines whether memory 126 is current in an idle state. In the event that memory 126 is currently idle, then in step 932, configuration logic 424 may preferably download the updated contents of arbitration configuration register 250 into local register 932. Arbiter 420 may then advantageously reconfigure arbitration table 412 with the updated contents of local register 428 to thereby complete the arbitration configuration procedure of FIG. 9.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. An apparatus for implementing a flexible arbitration mechanism in an electronic system, comprising:
command sources coupled to said electronic system for generating pending commands;
an arbiter coupled to said electronic system for referencing an arbitration table to choose a selected command from said pending commands to be executed by said electronic system, said arbitration table including ordered entries corresponding to said pending commands, said arbiter referencing said arbitration table in a table analysis sequence to choose said selected command; and
configuration logic coupled to said electronic system for dynamically reconfiguring said arbitration table in response to a configuration request that is generated after a processor device reprograms an arbitration configuration register.

2. The apparatus of claim 1 wherein said pending commands include at least one of a write data-transfer command and a read data-transfer command to a memory device.

3. The apparatus of claim 1 wherein said command sources include said processor device and one or more peripheral devices.

4. The apparatus of claim 1 wherein said electronic system includes said processor device, a memory device, and one or more peripheral devices that all communicate through a bridge device.

5. The apparatus of claim 4 wherein said bridge device includes a processor interface, a memory interface, one or more peripheral interfaces, and said arbitration configuration register.

6. The apparatus of claim 5 wherein said memory interface includes a memory controller, said arbiter, said arbitration table, said configuration logic, and command interfaces that each correspond to one of said processor device and said one or more peripheral devices.

7. The apparatus of claim 1 wherein said arbitration table is configured as a fairness arbitration table for normal conditions in said electronic system, said fairness arbitration table having said command sources alternately and equally represented.

8. The apparatus of claim 1 wherein said arbitration table is configured as a fairness burst arbitration table for burst transfers of said command sources, said fairness burst arbitration table having said command sources equally represented and alternately receiving multiple consecutive entries in said arbitration table.

9. The apparatus of claim 1 wherein said arbitration table is configured as a periodic source arbitration table that may be utilized to ensure that a designated command source in said electronic system receives a periodic and guaranteed access to a memory device.

10. The apparatus of claim 1 wherein said arbitration table is configured as a heavily-weighted partial burst arbitration table that may be utilized to ensure that a designated command source in said electronic system receives a periodic access to a memory device to perform burst transfer operations.

11. The apparatus of claim 1 wherein said arbitration table is configured as a lightly-weighted partial burst arbitration table that may be utilized to ensure that a designated command source in said electronic system receives a lightly-weighted access to a memory device to perform a burst transfer operation.

12. The apparatus of claim 1 wherein said arbiter evaluates said ordered entries of said arbitration table in an ascending order to identify a next table entry, said arbiter designating said selected command during said table analysis sequence by proceeding from lower-numbered entries to highernumbered entries of said arbitration table, said arbiter examining only those of said ordered entries in said table analysis sequence that correspond to said pending commands.

13. The apparatus of claim 1 wherein said command sources generate said pending commands to command interfaces of a memory interface, said command interfaces each corresponding to one of said command sources.

14. The apparatus of claim 13 wherein said command interfaces each send an arbitration request to said arbiter after receiving one of said pending commands.

15. The apparatus of claim 14 wherein said arbiter examines said arbitration table for said pending commands by utilizing said table analysis sequence.

16. The apparatus of claim 15 wherein said arbiter performs said table analysis sequence by evaluating said ordered entries of said arbitration table in an ascending order to identify a next table entry, said arbiter designating 25 said selected command during said table analysis sequence by proceeding from lower-numbered entries to higher-numbered entries of said arbitration table, said arbiter examining only those of said ordered entries in said table analysis sequence that correspond to said pending commands.

17. The apparatus of claim 15 wherein said arbiter identifies a next table entry from said arbitration table, said next table entry corresponding to said selected command.

18. The apparatus of claim 17 wherein said arbiter notifies a corresponding one of said command interfaces regarding said next table entry corresponding to said selected command.

19. The apparatus of claim 18 wherein said corresponding one of said command interfaces propagates said selected command to a memory controller.

20. The apparatus of claim 19 wherein said memory controller formats said selected command, and then sends said selected command to said memory device.

21. The apparatus of claim 20 wherein said memory device executes said selected command received from said memory controller to perform a data transfer operation for said electronic system.

22. The apparatus of claim 1 wherein said processor device reprograms said arbitration configuration register in response to program instructions from an application software program due to an altered operating =environment of said electronic system.

23. The apparatus of claim 22 wherein said configuration logic detects a change in said arbitration configuration register by comparing said arbitration configuration register with a local register coupled to said configuration logic.

24. The apparatus of claim 23 wherein said configuration logic compares said arbitration configuration register with a local register coupled to said configuration logic by utilizing a comparator device.

25. The apparatus of claim 23 wherein said configuration logic generates a configuration request to update said arbitration table after said configuration logic detects said change in said arbitration configuration register.

26. The apparatus of claim 23 wherein said configuration logic monitors a current state of a command target, said command target including at least one of an electronic device and a memory device.

27. The apparatus of claim 26 wherein said configuration logic monitors said current state of said memory device by monitoring a memory bus state by utilizing a memory controller.

28. The apparatus of claim 23 wherein said configuration logic downloads updated contents of said arbitration configuration register into said local register in response to detecting said a change in said arbitration configuration register.

29. The apparatus of claim 28 wherein said configuration logic and said arbiter reconfigure said arbitration table from said local register after downloading said updated contents of said arbitration configuration register.

30. The apparatus of claim 29 wherein said arbiter utilizes said arbitration table after said arbitration table is reconfigured from said local register, said configuration logic subsequently performing additional arbitration configuration procedures for dynamically updating said arbitration table to thereby optimize performance of said electronic network.

31. A method for implementing a flexible arbitration mechanism in an electronic system, comprising the steps of:
generating pending commands from command sources coupled to said electronic system;
referencing an arbitration table with an arbiter coupled to said electronic system to choose a selected command from said pending commands to be executed by said electronic system, said arbitration table including ordered entries corresponding to said pending commands, said arbiter referencing said arbitration table in a table analysis sequence to choose said selected command; and
reconfiguring said arbitration table with configuration logic coupled to said electronic system in response to a configuration request that is generated after a processor device reprograms an arbitration configuration register.

32. The method of claim 31 wherein said pending commands include at least one of a write data-transfer command and a read data-transfer command to a memory device.

33. The method of claim 31 wherein said command sources include said processor device and one or more peripheral devices.

34. The method of claim 31 wherein said electronic system includes said processor device, a memory device, and one or more peripheral devices that all communicate through a bridge device.

35. The method of claim 34 wherein said bridge device includes a processor interface, a memory interface, one or more peripheral interfaces, and said arbitration configuration register.

36. The method of claim 35 wherein said memory interface includes a memory controller, said arbiter, said arbitration table, said configuration logic, and command interfaces that each correspond to one of said processor device and said one or more peripheral devices.

37. The method of claim 31 wherein said arbitration table is configured as a fairness arbitration table for normal conditions in said electronic system, said fairness arbitration table having said command sources alternately and equally represented.

38. The method of claim 31 wherein said arbitration table is configured as a fairness burst arbitration table for burst transfers of said command sources, said fairness burst arbitration table having said command sources equally represented and alternately receiving multiple consecutive entries in said arbitration table.

39. The method of claim 31 wherein said arbitration table is configured as a periodic source arbitration table that may be utilized to ensure that a designated command source in said electronic system receives a periodic and guaranteed access to a memory device.

40. The method of claim 31 wherein said arbitration table is configured as a heavily-weighted partial burst arbitration table that may be utilized to ensure that a designated command source in said electronic system receives a periodic access to a memory device to perform burst transfer operations.

41. The method of claim 31 wherein said arbitration table is configured as a lightly-weighted partial burst arbitration table that may be utilized to ensure that a designated command source in said electronic system receives a lightly-weighted access to a memory device to perform a burst transfer operation.

42. The method of claim 31 wherein said arbiter evaluates said ordered entries of said arbitration table in an ascending order to identify a next table entry, said arbiter designating said selected command during said table analysis sequence by proceeding from lower-numbered entries to higher-numbered entries of said arbitration table, said arbiter examining only those of said ordered entries in said table analysis sequence that correspond to said pending commands.

43. The method of claim 31 wherein said command sources generate said pending commands to command interfaces of a memory interface, said command interfaces each corresponding to one of said command sources.

44. The method of claim 43 wherein said command interfaces each send an arbitration request to said arbiter after receiving one of said pending commands.

45. The method of claim 44 wherein said arbiter examines said arbitration table for said pending commands by utilizing said table analysis sequence.

46. The method of claim 45 wherein said arbiter performs said table analysis sequence by evaluating said ordered entries of said arbitration table in an ascending order to identify a next table entry, said arbiter designating said selected command during said table analysis sequence by proceeding from lower-numbered entries to higher-numbered entries of said arbitration table, said arbiter examining only those of said ordered entries in said table analysis sequence that correspond to said pending commands.

47. The method of claim 45 wherein said arbiter identifies a next table entry from said arbitration table, said next table entry corresponding to said selected command.

48. The method of claim 47 wherein said arbiter notifies a corresponding one of said command interfaces regarding said next table entry corresponding to said selected command.

49. The method of claim 48 wherein said corresponding one of said command interfaces propagates said selected command to a memory controller.

50. The method of claim 49 wherein said memory controller formats said selected command, and then sends said selected command to said memory device.

51. The method of claim 50 wherein said memory device executes said selected command received from said memory controller to perform a data transfer operation for said electronic system.

52. The method of claim 31 wherein said processor device reprograms said arbitration configuration register in response to program instructions from an application software program due to an altered operating environment of said electronic system.

53. The method of claim 52 wherein said configuration logic detects a change in said arbitration configuration register by comparing said arbitration configuration register with a local register coupled to said configuration logic.

54. The method of claim 53 wherein said configuration logic compares said arbitration configuration register with a local register coupled to said configuration logic by utilizing a comparator device.

55. The method of claim 53 wherein said configuration logic generates a configuration request to update said arbitration table after said configuration logic detects said change in said arbitration configuration register.

56. The method of claim 53 wherein said configuration logic monitors a current state of a command target, said command target including at least one of an electronic device and a memory device.

57. The method of claim 56 wherein said configuration logic monitors said current state of said memory device by monitoring a memory bus state by utilizing a memory controller.

58. The method of claim 53 wherein said configuration logic downloads updated contents of said arbitration configuration register into said local register in response to detecting said a change in said arbitration configuration register.

59. The method of claim 58 wherein said configuration logic and said arbiter reconfigure said arbitration table from said local register after downloading said updated contents of said arbitration configuration register.

60. The method of claim 59 wherein said arbiter utilizes said arbitration table after said arbitration table is reconfigured from said local register, said configuration logic subsequently performing additional arbitration configuration procedures for dynamically updating said arbitration table to thereby optimize performance of said electronic network.

61. The method of claim 31 wherein said arbiter utilizes a rotating examination sequence by changing starting points in said table analysis sequence for performing successive arbitration procedures to thereby identify corresponding next table entries.

62. An apparatus for implementing a flexible arbitration mechanism in an electronic system, comprising:
means for generating pending commands from command sources coupled to said electronic system;
means for referencing an arbitration table to choose a selected command from said pending commands to be executed by said electronic system, said arbitration table including ordered entries corresponding to said pending commands, said means for referencing examining said arbitration table in a table analysis sequence to choose said selected command; and
means for reconfiguring said arbitration table in response to a configuration request that is generated after a processor device reprograms an arbitration configuration register.

63. An apparatus for implementing a flexible arbitration mechanism in an electronic system, comprising:
command sources coupled to said electronic system for generating pending commands;
an arbiter coupled to said electronic system for referencing an arbitration table to choose a selected command from said pending commands to be executed by said electronic system; and
configuration logic coupled to said electronic system for dynamically reconfiguring said arbitration table.
